(19) United States
(12) Patent Application Publication
(10) Pub. No.: US 2008/0181397 A1
(43) Pub. Date: Jul. 31, 2008

(54) SECURE DATA TRANSMISSION AND STORAGE USING LIMITED-DOMAIN FUNCTIONS

(76) Inventor: JOHN WILSON DORMINY, McDonough, GA (US)

Correspondence Address: TROUTMAN SANDERS LLP, 600 PEACHTREE STREET , NE, ATLANTA, GA, 30308, US

(21) Appl. No.: 12/020,497

(22) Filed: Jan. 25, 2008

Related U.S. Application Data
(60) Provisional application No. 60/897,487, filed on Jan. 25, 2007.

(51) Int. Cl. H04L 9/30; H04L 9/28

(52) U.S. Cl. 380/30; 380/28

(57) ABSTRACT

An encryption system and method using a set of reversible functions that iteratively reduce the message to be encrypted. In an exemplary embodiment, an encryption module can first receive a data set, or a message, to be encrypted. In a single iterative step, the message can be reduced to a smaller message through the use of a tailored first function, a reduction process. A second function can generate an extra data set based on the message, which can be essential to decrypting the message later. The iterations continue until the reduction process can no longer reduce the message. When the iterations cease, the resulting encrypted message can comprise the extra data sets output during the iterations. Because the utilized functions can be reversible, a decryption module can effect decryption by simply reversing the steps of encryption.

### CROSS-REFERENCE TO RELATED APPLICATIONS

This application claims the benefit of U.S. Provisional Patent Application No. 60/897,487, filed 25 Jan. 2007, which is incorporated herein by reference in its entirety as if fully set forth below.

### BACKGROUND OF THE INVENTION

1. Technical Field of the Invention

The various embodiments of the present invention relate generally to encryption technology. More specifically, the various embodiments of the present invention relate to secure data transmission and storage using limited-domain functions.

2. Description of Related Art

With the development of computer technology, the storage and transfer of information in digital form has rapidly increased. There are many applications, including electronic mail systems, bank systems and data processing systems, where transferred information must pass over communications channels which may be monitored by electronic eavesdroppers. While the degree of security required may vary for various applications, it is generally important for all of these examples that the substance of particular communications pass directly from a sender to an intended receiver without intermediate parties being able to interpret the transferred message. In addition, there are further instances where information stored on a computer must be protected from snoopers who have access to the memory.

In general, cryptographic systems are adapted either to securely store a message or to transfer a message between remote locations. Cryptographic systems generally include at least one encoding device and at least one decoding device. For secure transfer of a message, the encoding and decoding devices are at different location and are coupled to a communication channel. For digital systems, the message is defined to be a digital message, M, that is, a sequence of symbols from some alphabet. In practice, the alphabet is generally chosen to be the binary alphabet consisting of the symbols 0 and 1.

Each encoding device is an apparatus which accepts two inputs: a message-to-be-encoded, M, and an encoding key or operator, E. Each encoding device transforms the message M in accordance with the encryption operator to produce an encoded version C of the message (which is denoted as the ciphertext) where C=E(M). The encoding key and the ciphertext are also digital sequences.

Each decoding device is an apparatus which accepts two inputs: a ciphertext-to-be-decoded C and a decoding key or operator, D. Each decoding device transforms the ciphertext in accordance with the decryption operator to produce a decoded version M′ of the ciphertext where M′=D(C), or M′=D(E(M)). Like the encoding key, the decoding key and decoded message M′ are also digital sequences. The encoding and decoding keys are selected so that M′=M for all messages M.

In operation, a message, once encoded into ciphertext, is transmitted over the channel to a recipient who decodes the received ciphertext to obtain the original message M. Thus, a recipient sees the original message M as the output of his decoding device.

To a large degree, the quality of performance of a cryptographic system depends on the complexity of the encoding and decoding devices. Regarding the problem of ensuring privacy of communications for a system where an eavesdropper can listen to every message transmitted on the communications channel (which might, for example, be a radio link), the effectiveness of the system depends upon the ability to ensure that the eavesdropper is unable to understand any such overheard messages.

Originally, encryption consisted of the use of substitution ciphers. For example, each character might be substituted for another character, in a one-to-one mapping. The encoding device would need to know the mapping in one direction, and the decoding device would know the reverse mapping. Of late, encryption systems fall into to general categories, symmetric encryption and asymmetric encryption. While symmetric encryption is relatively simple to implement and provides for fast execution, symmetric encryption schemes can be broken with adequate patience and resources. Asymmetric encryption systems are more difficult to break but are also more difficult to implement and time-consuming to execute.

In a symmetric encryption system, a key is shared between the encrypting and the decrypting process. The key must be secret, but the ciphertext encrypted under the key can be transmitted over an otherwise unprotected communications medium which is subject to eavesdropping by an adversary. The adversary is unable to recover the plaintext due to lack of knowledge of the key. In well-designed symmetric encryption systems, all k bits of a key are necessary for the encryption and decryption algorithms to function properly. Examples of symmetric encryption algorithms are the Data Encryption Standard (DES), originally detailed by Ehrsam et al. in U.S. Pat. No. 3,962,539; block ciphers constructed using the CAST design technique of Adams, details of which are given in U.S. Pat. No. 5,511,123; well known proprietary block ciphers such as the RC2 cipher of RSA Data Security Inc.; and algorithms disclosed in U.S. Pat. Nos. 6,182,216 and 7,305,085.

Symmetric encryption algorithms may be attacked by an adversary who, given one known plaintext-ciphertext pair of data, tries all 2^{k} possible k-bit keys to see which one maps the known plaintext to the known ciphertext. This is referred to as an exhaustive key search. In a well-designed symmetric encryption system, an adversary can do no better than mount such an exhaustive attack. In this case, the bit-length k of the key gives an indication of the strength of the algorithm, the work required for an attack is 2^{k} operations, and the probability of any particular key being guessed is (½^{k}), assuming that all keys are equally probable.

Asymmetric cryptographic techniques, which involve a different key for decoding than for encoding, also play a major role in commercial cryptographic solutions in the field of information security. An asymmetric encryption algorithm, for example, is parameterized by a pair of related numbers, known as a private key and a public key. The public key, known to everyone, allows anyone to encrypt data for a specific intended recipient; the private key, known only to the intended recipient, allows only that individual to decrypt the data. Another asymmetric technique, referred to as DH key exchange after Diffie and Hellman, and described by Hellman, Diffie and Merkle in U.S. Pat. No. 4,200,770, allows two parties to establish a shared secret key using only publicly known parameters. DH can also be used for key transfer to provide functionality equivalent to RSA key transfer; this is commonly called ElGamal encryption (see T. ElGamal, “A public key cryptosystem and a signature scheme based on discrete logarithms,” IEEE Transactions on Information Theory volume 31, 1985, pages 469-472). Variations of ElGamal encryption have also been proposed and implemented using elliptic curve cryptography.

In practice, asymmetric techniques are often used for key management applications, and in particular, for the transfer of a symmetric key from one party to one or more other parties. Often a different symmetric key is used for each transmission from a party A to a party B; in this case, the symmetric key is referred to as a session key. The session key is then typically used in a symmetric algorithm, for example, an encryption algorithm such as DES or a CAST algorithm. This is done because symmetric encryption algorithms are often faster for bulk data encryption than asymmetric techniques, while the latter allow for more convenient solutions to the key distribution problem because only the authenticity of a public key need be assured, and this is easier than distributing keys whose secrecy must be guaranteed. Asymmetric encryption, by its nature, is very expensive in terms of processing time, largely because it is based on complex number-theoretical operations and cannot be easily implemented in hardware.

Accordingly, there is a need for an encryption scheme that is efficient, simple to implement, and not easily broken. It is to such an encryption scheme that the present invention is directed.

### BRIEF SUMMARY OF THE INVENTION

The present invention is an encryption and decryption system and method utilizing a set of key-based functions to iteratively reduce, and thereby encrypt, the data to be secured. Because the functions can be reversible, decryption can simply be the reverse of encryption. The actions involved in encryption and decryption can be stored on a computer-readable medium in the form of computer-readable instructions.

In an exemplary embodiment, an encryption module receives as input a first set of data, such as a message, to be encrypted. It should be noted that, throughout this Application, the term “message” refers to more than a communication from one entity to another; the term includes all types of digital data. The encryption module can have any implementation, including a device, function, a program, or part of a program. An iterative loop can perform most of the work in encrypting a message. In an exemplary embodiment, functions within the iterative loop might only be able to act upon messages within a certain domain, U. Before the message enters the iterative loop, it can enter a preprocessing step, and it can be transformed into a message, or a data set, that is a member of the set U. Such transformation can also output a pre-transformation data set, which can be used during decryption.

At each iterative step, a reducing unit and a data-generating unit can act on the message. Like the encryption module, these units, or modules, can be of any implementation, including devices, functions, programs, or parts of programs, and the units need not have the same implementation. The reducing unit reduces the message to a smaller data set, or a second message, by way of a reduction process. The data-generating unit of the iterative loop outputs some extra data set based on the message. Then, the message can be set to equal the second, reduced message. If the new message can be further reduced via the reducing unit, then the iterations can continue. In an exemplary embodiment, the reducing unit implements a function that has a bounded limit. In other words, the message can be reduced until it hits the predetermined limit, which is determined by the key and the functions chosen for encryption and decryption. Once the message reaches the predetermined limit, the message can be reduced no more by the reducing unit. At that point, the iterations terminate. The iterating, or repeating, can be controlled by a third unit. After the iterations terminate, the message can enter post-processing. The encrypted message can comprise the pre-transformation data set as well as any extra data sets output by the data-generating unit.

Reduction, as performed by the reducing unit of the iterative loop, can be implemented in any number of ways. In an exemplary embodiment, suppose M bits of memory are needed to represent a member of U requiring the least bits of memory for representation without compression. The reduction process can transform an input data set to an output reduced data set such that if the input data set can be represented in N bits of memory without compression, where N is greater than M, then the output data set can also be represented in N bits of memory without compression. Further, if the reduction process were applied iteratively by inputting the output of the previous reduction process at each iteration, then eventually, a resulting output data set could be represented by N−1 bits of memory without compression.

In another exemplary embodiment, where the set U is an ordered set, suppose the input data set represents the i^{th} smallest member of U. The reduction process can transform the input data set into an output data set such that the output data set represents, at most, the i−1^{th} smallest member of U.

In an exemplary embodiment, a decryption module can be simply the reverse of the encryption module. To decrypt a ciphertext message, or data set, the first step can be to reverse any post-processing done by the encryption module. Then, the iterations can begin with the message set to the smallest message, or data set, reached by the encryption module. This smallest message is the bounded limit of the function implemented by the reducing unit. The smallest message can be received by the decryption module, or alternatively, because this smallest message is predetermined, the decryption module can calculate this smallest message, or can retrieve this smallest message from storage.

At each iteration, an extra data set and the current message can be combined in an enlargement process, which can be performed by a first unit or module, to reverse the effects of the reducing and data-generating units of the encryption module. The first reversal unit can be of any implementation, including a device, a function, a program, or part of a program. If there remain extra data sets that have yet to be used in decryption, the iterations can continue. Otherwise, the iterations can cease. The iterating, or repeating, can be controlled by a second reversal unit. The resulting message can be transformed back to the original message, or data set, by incorporating the pre-transformation data and the message and reversing the effects of the pre-iterations transformation. Then, preprocessing can need to be reversed to reconstruct the original message, or data set.

Enlargement, as performed by the first unit of the iterative loop, can be implemented in any number of ways. In an exemplary embodiment, suppose M bits of memory are needed to represent a member of U requiring the most bits of memory for representation without compression. The enlargement process can transform an input reduced data set to an output enlarged data set such that if the enlarged data set can be represented in N bits of memory without compression, where N is less than M, then the reduced data set can also be represented in N bits of memory without compression. Further, if the enlargement process were applied iteratively by inputting the output of the previous enlargement process at each iteration, then eventually, a resulting output enlarged data set could require N+1 bits of memory for representation without compression.

In another exemplary embodiment, where the set U is an ordered set, suppose the input reduced data set represents the i^{th} smallest member of U. The reduction process can transform the reduced data set into an enlarged data set such that the enlarged data set represents, at least, the i+1^{th} smallest member of U.

### BRIEF DESCRIPTION OF THE FIGURES

FIG. 1. displays a diagram representation of a network environment on which the invention is implemented in accordance with an exemplary embodiment of the present invention.

FIG. 2. displays a diagram representation of a system environment on which the invention is implemented in accordance with an exemplary embodiment of the present invention.

FIG. 3 is a diagram of a system of encryption according to the present invention.

FIG. 4 is a diagram of another system of encryption according to the present invention.

FIG. 5 is a diagram of the encryption step of an exemplary encryption module.

FIG. 6 is a diagram of the encryption step of an exemplary encryption module in more detail.

FIG. 7 is a diagram the actions performed by an exemplary decryption module.

FIG. 8 is a diagram of the decryption step of an exemplary decryption module in more detail.

### DETAILED DESCRIPTION OF THE INVENTION

To facilitate an understanding of the principles and features of the invention, it is explained hereinafter with reference to its implementation in an illustrative embodiment. In particular, the invention is described in the context of being a computer-executable method of encrypting a message for secure transfer or storage.

The implementations described hereinafter as making up the various elements of the invention are intended to be illustrative and not restrictive. Many suitable implementations that would perform the same or a similar function as implementations described herein are intended to be embraced within the scope of the invention. Such other implementations not described herein can include, but are not limited to, for example, encryption methods incorporating other sets of key-based encryption functions that meet the criteria contemplated by this invention.

An exemplary embodiment of the present invention includes an encoding device or program, a decoding device or program, and a communication channel or a storage medium. If a message is to be securely transferred from one location to another, the encryption device, which can be at the first location, encrypts the message. The message then passes through the communication channel to the second location, where the message can be decrypted by the decryption device.

While standard encryption methods use multiple operations of rearrangements and substitutions, which generally preserve the original message length, an exemplary embodiment of the present invention can use reversible reduction operations iteratively. As the original message can be reduced in size, the ciphertext can increase in size until the message can be reduced no more. Information about each reduction can be stored in the ciphertext, thereby causing the ciphertext to increase in size. The functions used to reduce the message, and likewise increase the ciphertext, can be based on a key, which key can be a set of data.

An exemplary embodiment of the present invention can use a set of transformations meeting certain criteria, which criteria will be described in greater detail below. A first transformation, H, can map the plaintext, PM, to a message, M, which can be inputted into other of the encryption functions used in an exemplary embodiment. A transformation F can map M to a smaller message, M′, at each execution. A transformation G can take M to either 0 or 1. The outputs of G can be part of the ciphertext, the encrypted message. After F and G have operated on M, M can be set to M′, which was the output of F given M. F and G can be applied to the message remainder iteratively until the remainder is too small for F to act upon. At that point, the message can be entirely encrypted. Decryption works in the reverse. The reverse of F and G are applied to the ciphertext iteratively until there is no more ciphertext to act upon. Then, the reverse of H can be applied to reconstructed message, resulting in the decrypted original plaintext.

In an exemplary embodiment, the three transformations, or functions, meet the following criteria.

For a function F:
1. F:U→U, for a set U
2. for PM ∈ U, if PM is not the minimal member of U, F(PM)<PM, else F(PM)=PM
3. there may be an X,Y ∈ U, such that X≠Y and F(X)=F(Y), but there can be no Z, such that X,Y,Z ∈ U, X≠Y≠Z, and F(X)=F(Y)=F(Z).

In other words, F maps U to U. F takes as input a member of a set U, and outputs a member of the set U (which output need not be the same as the input member of U). For some PM, which is a member of a set U, if PM is not the minimal member of U, then when F takes PM as input, F's output is less than PM. But if PM is the minimal member of U, then F, which can only output members of U, outputs PM. Finally, there can be no more than two distinct members of U that, when taken as input to F, result in the same output.

For a function G:

1. G:U→{0,1}

2. if F(X)=F(Y) and X≠Y and X,Y ∈ U, then G(X)≠G(Y)

In other words, G maps U to the set of bits. G takes as input a member of the set U, and outputs either 0 or 1. And if F has the same output for distinct X and Y, which are both members of U, then G must output different results for that X and Y.

For a function H:

1. H:A→U and H:A→D, A is the set of all messages and D is a set data

2. there are no X,Y ∈ U, such that H(X)=H(Y) for both outputs

In other words, H maps any message (not necessarily a member of the set U) to the set of all messages and a set of data. H has two outputs. The first output is a member of U, while the second output is extra data, which will be explained further below. There are no distinct X and Y that, when taken as input to H, result in the same pair of outputs.

Before F can be applied to a message, PM, to be encrypted, PM can first be mapped to a member of the set U. The purpose of function H is to provide a means for such a mapping. H can take as input any message and outputs M, a member of U, as well as some additional data. This output M can then be used as input for F to begin the iterative process of reducing M to a minimal member of U while increasing the size of encrypted output, CM, with G. The additional data, D, output from H is information required by the decrypting program to reconstruct M from M′ when H is reversed. The individual D's output during each iteration can reach the decrypting module by any means. They can be stored until encryption is complete and then transferred to another location, such as to the decryption module or to a permanent storage device. Alternatively, the D's can be sent to a storage device or to the decrypting module piece by piece, so that after a single D is generated, it is sent without waiting for other D's to be generated. At each iteration, an output D can be stored for later use by a decrypting module, or it can be sent to the decrypting program before with.

Performing one iterative step of the encryption can require that both F and G act on the current message PM. With the input PM, F outputs PM′, which is also of the set U. The output of G can be stored or transferred for later use by a decrypting program. PM can be set to equal the output of F; PM←PM′. This set of actions can be repeated iteratively until PM equals the minimal member of U, and therefore, F can no longer be applied to PM with a result different than PM. When PM reaches the minimal member of U, a message can be sent to the decoding program to indicate the end of transmission.

A decrypting module can receive the bits outputted by G, as well as D, which all together comprise the encrypted message CM. When the decoding program receives the encrypted message CM, the portion of CM corresponding to D can be extracted and removed from CM. Some M can be set to the minimal member of the set U. Together, M, CM (after having removed D), and D can comprise the information needed to recreate the original plaintext message.

While CM still contains bits (which were outputted from G during encryption), the last bit received can be stored in B and removed from CM. The decryption program determines the one or two members of U which, when taken as input to F, result in an output of M. If two such members are found, X and Y, then according to the criteria for G, only one of G(X) and G(Y) can be equal to B. If G(X)=B then M can be set to X; otherwise, if G(Y)=B, then M can be set to Y. These actions comprise one iteration of decryption, and are repeated iteratively until CM no longer contains bits. When CM no longer contains bits, the function H can be reversed given D and M, returning the original message PM.

More specifically, an exemplary embodiment of the present invention can use the following functions, in which the key, K, on which the encryption function, F, G, and H, are based is the set {p, q}, for some predetermined p and q such that 2q>p>q, and % represents the modulo function:

1. F(M)=(M−M % p)*(q/p)

2. G(M)=0, if M % p<p−q; else G(M)=1

3. H(M)={floor(M*(q/p)), M % p}, where M % p is the extra data

The key on which the above functions are based is the pair (p, q). Because 2q>p>q, there are no more than two multiples of q between k*p and (k+1)*p. Thus there are no more than two possible distinct messages that can result in the same output of F. Further, 0 is the only message such that F(M)=M. For all others, M is non-zero and q/p<1, so F(M)<M. In other words, for non-zero messages, F reduces the message to a smaller message in set U. Also, F(M)*(p/q)+M % q=M, and (F(M)*p)+(q*(M % p))=q*M, and F(M)*p=q*(M−M % p). Since there are no more than two multiples of q between two consecutive multiples of p, M % p is either (q−(F(M) % q)) % q or (q−(f(M) % q)) % q+q. The former of these is less than p−q, and the latter is greater than q−1 (since p<2q and p−q<q−1). According to these functions, the set of messages U consists of all messages divisible by p, so H has a unique output for each positive M. Therefore, these three functions F, G, and H fulfill the criteria for key-based functions for an exemplary embodiment of the present invention. The choice of this set of functions, however, is not meant to be a limitation of the present invention, and any set of functions meeting the criteria can be used.

To demonstrate the efficacy of this exemplary embodiment of the present invention using the above three functions, one need only consider the reversibility of a single iterative step. If a single iteration can be reversed, then an encrypted message, which results from multiple iterations, can be decrypted through the reversal of multiple steps. Thus, consider an arbitrary step, with initial message M, final message F(M), and a bit, B, added to the encrypted message. Given the above F, (M)/q=floor(M/p), so M/p−1<F(M)/q<=M/p, and (M−p)/p<F(M)/q<=M/p. As M is divisible by q, and p is between q and 2q, there are no more than two possibilities for a number divisible by q in a range of length p. One of these possibilities is the message M; the other possibility is M plus or minus q, depending on the result of M % p. If M>=q % p, given that 2q>p, then F(M+p)>F(M). Thus, if M>q % p, then F(M−q)=F(M). Otherwise, if M<p−(q % p), then F(M+q)=F(M). (There is also a possibility that p−q<=M<q. In that case, neither F(M+q) nor F(M−q) are equal to F(M).).

A decryption program reverses the iteration, starting with a message M′. The program finds the smallest M such that F(M)=M′. As shown above, multiple M can yield the same result after F is applied. The decryption program tests whether B is equal to 1. If B is 1, M must have been greater than or equal to p−(q % p), so M should be increased by q to the correct value. Otherwise, M must be lesser of the two possibilities, so no increase by q is necessary. Because the decryption step accounts for two possible values of M, an arbitrary iteration is reversible. As any one iteration is reversible, any number of iterations in sequence is reversible. Therefore, applying a decryption program of an exemplary embodiment to a message encrypted with an encryption program of the present invention results in the original message.

Referring now to the figures, wherein like reference numerals represent like parts throughout the figures, the present invention will be described in detail. The present invention comprises a system and method of encryption.

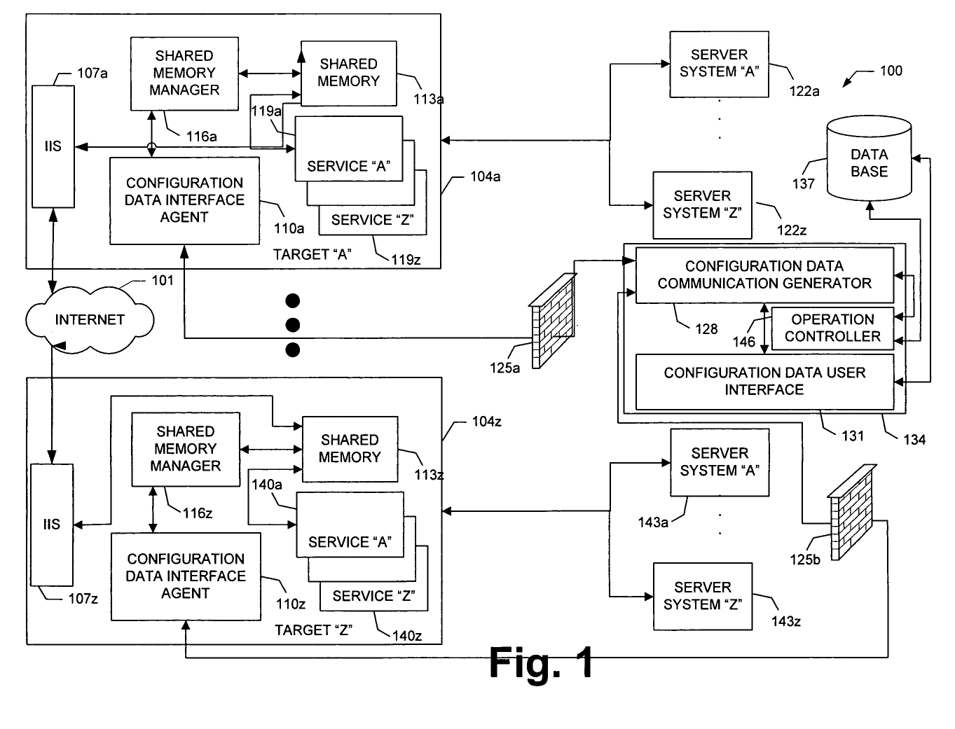

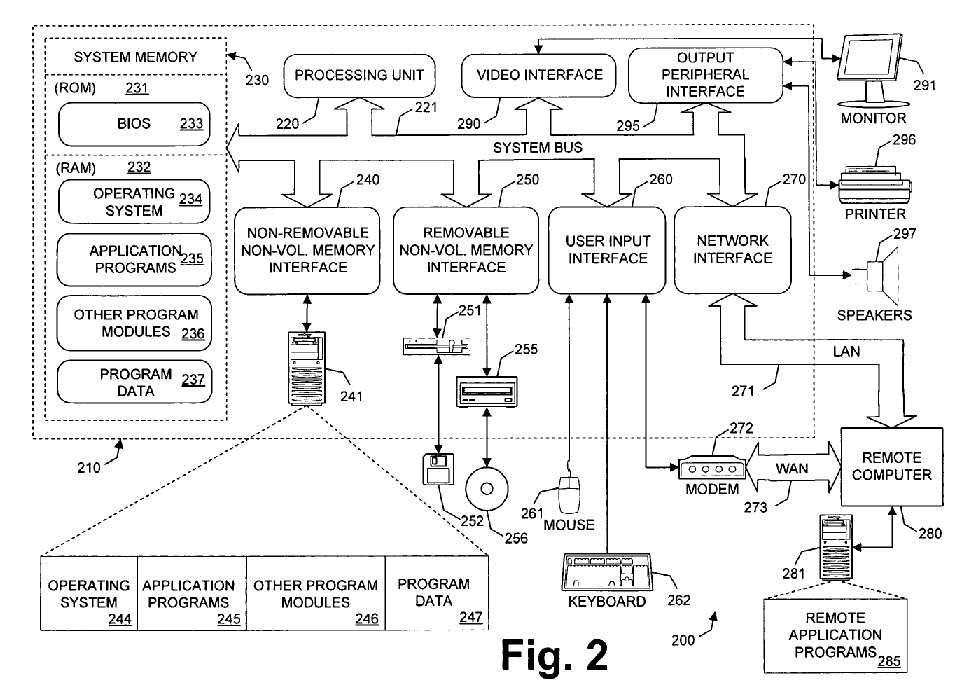

FIG. 1 displays a block diagram representation of a network environment 100 on which the invention can implemented in accordance with an exemplary embodiment of the present invention. The network environment 100 comprises an operator system 134 residing at a first location. The operator system 134 is configured with hardware and software (see FIG. 2) appropriate to perform tasks and provide capabilities and functionality as described herein. The operator system 134 comprises a configuration data communication generator 128, a configuration data user interface 131, and an operation controller 146.

The configuration data user interface 131 provides an operator or administrator with a user interface to add or modify data, such as configuration data, which is stored in a database 137, described below. In the exemplary embodiment of the present invention, the configuration data user interface 131 comprises program modules or machine instructions that perform the above-described tasks when executed on the operator system's 134 central processing unit (CPU).

The configuration data user interface 131 connects communicatively to the configuration data communication generator 128. The configuration data communication generator 128 is adapted to receive data, such as configuration data, from the configuration data user interface 131. In the exemplary embodiment of the present invention, the configuration data communication generator 128 comprises program modules or machine instructions that perform certain tasks when executed by the CPU. Additionally, the configuration data communication generator 128 creates executable machine instructions or code which incorporates the configuration data received from the configuration data user interface 131. The generated code is then sent to target systems 104a, 104z, described below, for configuration data updates. The configuration data communication generator 128 connects communicatively to target systems 104a,104z. Preferably, the configuration data communication generator 128 connects to the target systems 104a, 104z via a secure communication link and through a firewall 125a, 125b, described below. Such connection is generally established via a typical network protocol. For example, and not limitation, the configuration data communication generator 128 connects to the target systems 104a,104z using the simple object access protocol (SOAP) to exchange structured and type information via the network environment 100. In the exemplary embodiment of the present invention, the executable machine instructions or code generated by the configuration data communication generator 128, described above, is implemented in extensible markup language (XML).

The operation controller 146 connects communicatively to the database 137 and the configuration data communication generator 128. The operation controller 146 is adapted to receive data from the database 137 and provide data to the configuration data communication generator 128. In the exemplary embodiment of the present invention, the operation controller 146 comprises program modules or machine instructions that perform certain tasks when executed by the CPU. For example, and not limitation, the operation controller 146 determines whether a target system's 104a, 104z shared memory 113a, 113z, described below, is empty (i.e., because the target system just entered the network after reboot or because the target system is a newly added system). If such a determination is made, the operation controller 146 retrieves data from the database 137 to provide to the configuration data communication generator 128, which in turn provides the data to the appropriate target system 104a, 104z.

The operator system 134 connects communicatively to a database 137 which stores data. The database 137 is a memory device capable of storing and retrieving data including, but not limited to, random access memory (RAM), flash memory, magnetic memory devices, optical memory devices, hard disk drives, removable volatile or non-volatile memory devices, optical storage mediums, magnetic storage mediums, or RAM memory cards. Alternatively, the database 137 may be a remote storage facility accessible through a wired and/or wireless network system. Additionally, the database 137 may be a memory system comprising a multi-stage system of primary and secondary memory devices, as described above. The primary memory device and secondary memory device may operate as a cache for the other or the second memory device may serve as a backup to the primary memory device. In yet another example, the database 137 may be a memory device configured as a simple database file. The database 137 is preferably implemented as a searchable, relational database using a structured-query-language (SQL). Typically, the database 137 stores the persisted configuration data and connection strings for the services 119a, 119b, 140a, 140z located on the target system 104a, 104z.

In the exemplary embodiment of the present invention, the network environment 100 comprises a plurality of target systems 104a, 104z residing at multiple locations. The target systems 104a, 104z are configured with hardware and software (see FIG. 2) appropriate to perform tasks and provide capabilities and functionality as described herein. Each target system 104a, 104z comprises a web server, such as Internet Information Server (IIS) 107a, 107z; shared memory 113a, 113z; a shared memory manager 116a, 116z; a configuration data interface agent 110a, 110z; and a plurality of services 119a, 119z, 140a, 140z. The ellipsis between target system “A” 104a and target system “Z” 104z illustrates that a plurality of target systems may exist in the network environment 100 and, therefore, the network environment 100 is not limited to two target systems as shown in FIG. 1.

The IIS 107a, 107z connects communicatively to a remote network such as, but not limited to, the Internet 101 or a local area network (LAN). One skilled in the art will recognize that the IIS 107a, 107z is a web server designed to deliver web documents to remote clients that request such web documents. IIS 107a, 107z is a web server designed to run on “WINDOWS NT®” platforms available from Microsoft Corporation of Redmond, Wash. Additionally, the IIS 107a, 107z connects communicatively to the shared memory 113a, 113z.

The shared memory manager 116a, 116z connects communicatively to the shared memory 113a, 113z which contains data, such as configuration data. The shared memory manager 116a, 116z comprises program modules or machine instructions that perform certain tasks when executed by the CPU. In the exemplary embodiment of the present invention, the shared memory manager 116a, 116z handles all requests for data residing in shared memory 113a, 113z. Additionally, the shared memory manager 116a, 116z updates and adds data to the shared memory 113a, 113z. In the exemplary embodiment of the present invention, the shared memory manager 116a, 116z only updates and adds data to the shared memory 113a, 113z if requested by the configuration data interface agent 110a, 110z, described below, otherwise the shared memory manager 116a, 116z only provides read access to the shared memory 113a, 113z.

The shared memory 113a, 113z stores data and provides data to the shared memory manager 116a, 116z. In the exemplary embodiment of the present invention, the shared memory 113a, 113z is a volatile memory device (often called main memory) capable of storing and retrieving data including, but not limited to, random access memory (RAM), or any other memory device that provides rapid storing and retrieving of data. The data residing in shared memory 113a, 113z includes, but is not limited to, configuration data, ports, wires, genres, records, or permission schemas. Additionally, the shared memory 113a, 113z maintains configuration data, ports, and wires relevant to the local target system 104a, 104z. Therefore, the content of shared memory 113a, 113z across the network environment 100 differs for each target system 104a, 104z.

The plurality of services 119a, 119z, 140a, 140z include, but are not limited to, program modules, applications, machine instructions, software code, or any combination thereof. Generally, services 119a, 119z, 140a, 140z perform tasks and provide desirable capabilities in order to reach a specific result. Services 119a, 119z, 140a, 140z typically require system resources and configuration data to perform properly. In addition, services 119a, 119z, 140a, 140z may require access to back-end functionality provided on various server systems (also called resources) 122a, 122z, 143a, 143z. The services 119a, 119z, 140a, 140z connect communicatively to the shared memory 113a, 113z. For example, and not limitation, if a service needs configuration data or a connection to a server system, the service 119a, 119z, 140a, 140z sends a request to the shared memory 113a, 113z for such data. The target system 104a, 104z may contain a plurality of services 119a, 119z, 140a, 140z and, therefore, should not be limited to the number of services shown in FIG. 1.

Server systems 122a, 122z, 143a, 143z may be configured with hardware and software (see FIG. 2) appropriate to perform tasks and provide capabilities and functionality as described herein. Server systems 122a, 122z, 143a, 143z typically provide back-end support to the services 119a, 119z, 140a, 140z running on the target systems 104a, 104z. Each server system 122a, 122z, 143a, 143z may contain differing support program modules, applications, software, or hardware. For example, one server system may contain billing software, while another server system contains authentication software. In the exemplary embodiment of the present invention, services 119a, 119z, 140a, 140z connect to server systems 122a, 122z, 143a, 143z for support and functionality.

The configuration data interface agent 110a, 110z connects communicatively to the shared memory manager 116a, 116z. The configuration data interface agent 110a, 110z provides data, such as configuration data, to the shared memory manager 116a, 116z, which then updates shared memory 113a, 113z. Additionally, the configuration data interface agent 110a, 110z connects communicatively to the operator system 134 via a secured communication link. A secure communication link can be established by encrypting any communication through the secure communication link using secure sockets layer (SSL). In the exemplary embodiment of the present invention, the operator system 134 provides a communication, comprising configuration data from the database 137, to the configuration data interface agent 110a, 110z which then interprets the communication and provides the configuration data to the shared memory manager 116a, 116z for storing into shared memory 113a, 113z. Generally, only the configuration data interface agent 110a, 110z has access to the write-enabled APIs used to write data to shared memory 113a, 113z.

The target system 104a, 104z and the operator system 134 are separated by a firewall 125a, 125b. Typically, a firewall 125a, 125b is a system designed to prevent unauthorized access to a computer system or network and may be implemented by hardware, software, or a combination thereof. A firewall 125a, 125b assists in making a connection between two systems secure.

One skilled in the art will recognize that connecting communicatively may include any appropriate type of connection including, but not limited to, analog, digital, wireless and wired communication channels. Such communication channels include, but are not limited to, copper wire, optical fiber, radio frequency, infrared, satellite, or other media.

In an alternative embodiment of the present invention, the target systems 104a, 104z may not be in communication with an operator system 134. In such a configuration, the configuration data interface agent 110a, 110z does not receive configuration data from the database 137 via the configuration data communication generator 128. Instead, configuration data is retrieved from the local registry of the target system 104a, 104z. To change data in the shared memory 113a, 113z, the values in the registry of the target system 104a, 104z may be modified by an operator.

FIG. 2 illustrates an example of a suitable computing system environment 200 on which the invention is implemented. The computing system environment 200 is only one example of a suitable computing environment and is not intended to suggest any limitation as to the scope of use or functionality of the invention. Neither should the computing environment 200 be interpreted as having any dependency or requirement relating to any one or combination of components illustrated in the exemplary operating environment 200.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, or data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system for implementing the invention includes a general purpose computing device in the form of a computer 210. Components of computer 210 may include, but are not limited to, a processing unit 220, a system memory 230, and a system bus 221 that couples various system components including the system memory 230 to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 210 typically includes a variety of computer readable media. Computer readable media can be any available media that can be accessed by computer 210 and includes both volatile and nonvolatile, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates a hard disk drive 241 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus 221, but may be connected by other interface and bus structures, such as a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through an output peripheral interface 295.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

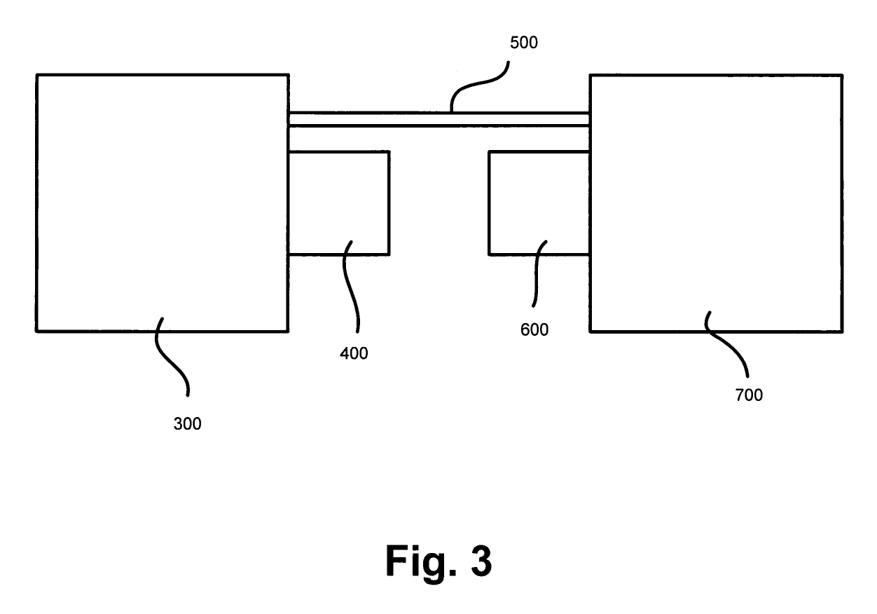

FIG. 3 is a schematic diagram of a system of encryption according to the present invention. This embodiment comprises a first computer 300, an encryption module 400, and unidirectional communication channel 500, a decryption module 600, and a second computer 700. The first computer 300 has stored a message to be securely transferred to the second computer 700. The first computer 300 is interfaced to the encryption module 400, which accepts as input the message from the first computer 300 and encrypts the message. The encryption module 400 outputs the encrypted message to the communication channel 500. The channel 500 can be implemented through any communication method and preferably comprises a serial cable coupled to a TCP/IP based network. The communication channel 500 connects to the decryption module 600, interfaced to the second computer 700. The decryption module 600 accepts input from both computer 700 and channel 500. Based on inputs from these sources, the decryption module 400 decrypts the message for use by the second computer 700.

Practically, this embodiment of the present invention could be used for a secure email system. A sender at a first computer 300 sends an email of a secure system to a recipient at a second computer 700. The encryption module 400, which is interfaced with the first computer 300, encrypts the email message according to the present invention. In an exemplary embodiment, the message is preprocessed and is then transformed by function H, which outputs extra data plus message to which functions F and G can be applied. The output message of H enters a cycle of iterations, during which F and G are applied to the message until the message is too small for F to be applied to the message again. Each output of G, as well as the extra data output of H, is sent along the communication channel 500 for later decryption. Together, these data compose the encrypted message. The communication channel 500 may or may not be a secure method of communication. For example, the message may be sent wirelessly over the air from the Pentagon to the handheld of a recipient in the Middle East. Alternatively, the message may be sent over a wired network from one attorney in a firm to another attorney in the same firm. Although the communication channel 500 may not be secure, because the message has been encrypted by the present invention, the message cannot be read by any third party.

The second computer 700 receives the encrypted message at the other end of the communication channel 500. The decryption module, interfaced to the second computer 700, decrypts the message according to the present invention. As F, G, and H are reversible functions, decryption is simply the reverse of encryption. The iterations of alternately applying F and G are reversed. The result of these iterations is sent to function H and then to the reverse preprocessor, which outputs the original message. After decrypting the message with the decryption module, the second computer 700 delivers the message to the recipient.

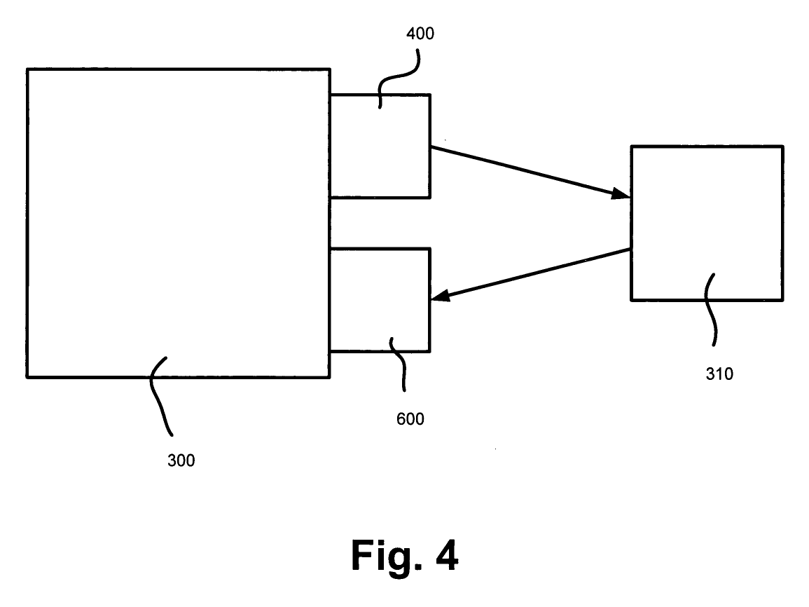

FIG. 4 is a schematic diagram of another system of encryption according to the present invention. This embodiment comprises a computer 300, an encryption module 400, a decryption module 600, and a storage device 310. The computer 300 has stored a message to be securely stored on the storage device 310. The storage device 310 can be located on the computer 300 or it can be an external storage medium. The computer 300 is interfaced to the encryption module 400, which accepts as input the message from the computer 300 and encrypts the message according to the present invention. As when the message is to be transferred across a communication channel 500, in an exemplary embodiment, the message is preprocessed and is then transformed by function H. H outputs extra data plus message to which functions F and G can be applied. The output message of H enters a cycle of iterations, during which F and G are applied to the message until the message is too small for F to be applied to the message again. Each output of G, as well as the extra data output of H, is sent to the storage device 310. Together, these data compose the encrypted message.

When an authorized user wants to access the encrypted message on the storage device, the message is sent to the decryption module 600 for decrypting. The decryption module 600, which is also interfaced to the computer 300, accepts input from both the computer 300 and the storage device 310. Based on inputs from these sources, the decryption module 400 decrypts the message for use by the computer 300 by reversing the encryption process as discussed above.

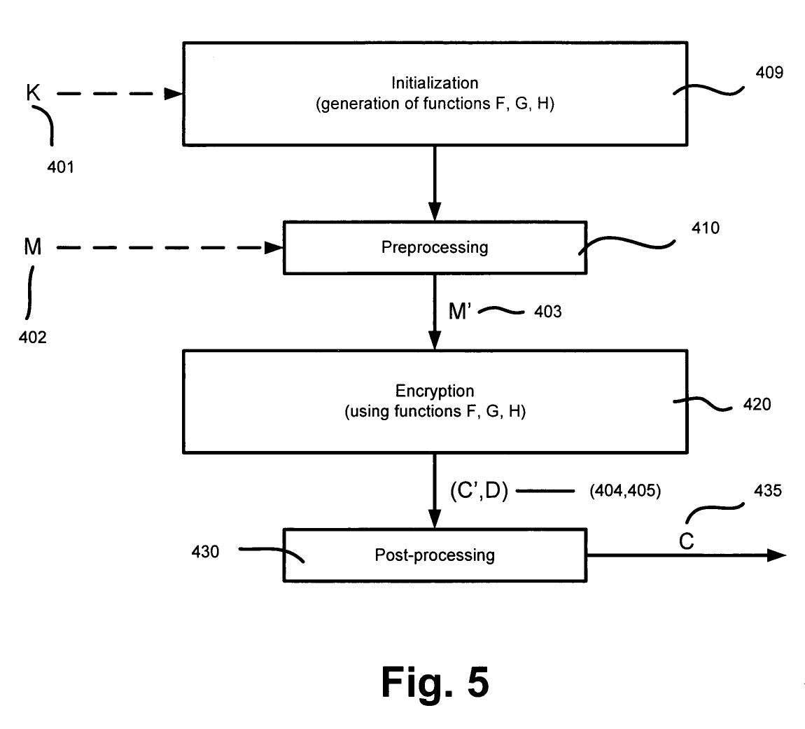

FIG. 5 is a schematic diagram of the encryption step of an exemplary encryption module. The key 401 is read into the encryption module 400 and is used to initialize 409 the encryption module 400, which computes three functions, F, G, and H, to be used during the encryption process. Preferably, F, G, and H are reversible functions based on the key 401. After the three functions have been calculated, message M 402 enters preprocessing 410. Preprocessing 410 can comprise any number of actions, including converting the message to a number, or using a blocking algorithm to break the message up into several smaller messages. Preprocessing can output one or more messages, M′ 403, corresponding to transformations of the input M 402. Preferably, preprocessing is reversible. The encryption module applies the encryption step 420 to resulting message, M′ 403. The encryption step 420 utilizes functions F, G, and H, transforming M′ 403 to a pair (C′ 404, D 405). The postprocessor 430 transforms the pair 404, 405 into a single ciphertext message C 435 which is output to the communication channel 500.

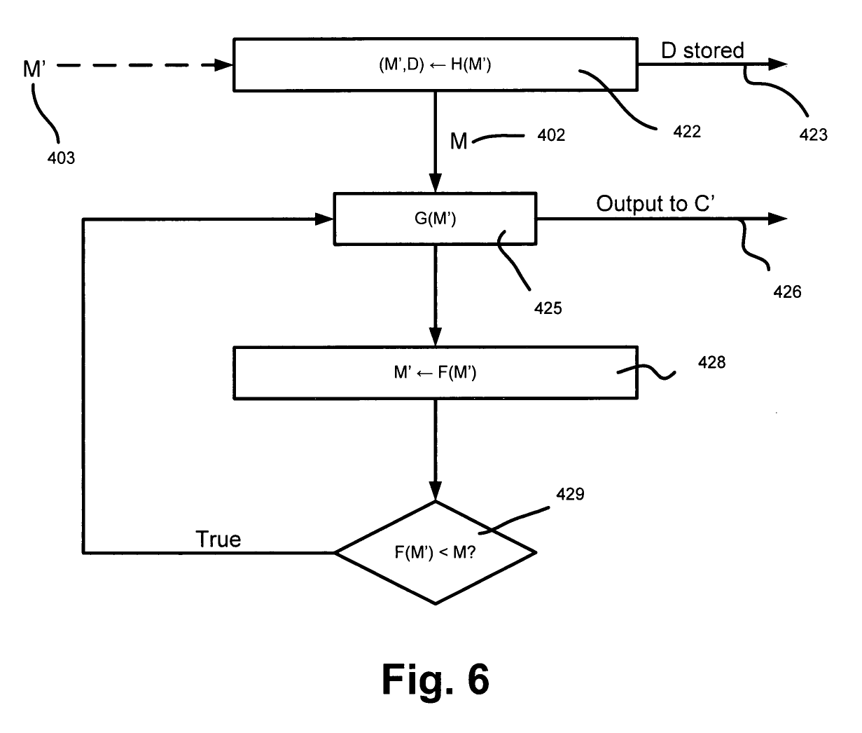

FIG. 6 is a schematic diagram of the encryption step of an exemplary encryption module in more detail. Message M′ 403 is input into the encryption step 420. Function H 422 is executed on M′ 403, resulting in the pair (M″, D). In 423, D is stored for later use by the post-processor, while M′ 403 is set to the value of M″. M 403 is inputted into function G 425. With this input, G 424, outputs a bit, which is sent to the post-processor in step 426. M′ is also inputted into function F 428, and M′ 403 is set to the resulting output of F(M′), which is a reduction of the original M′. Finally, the new M′ 403 is compared to the original M′ in 429, and if true the new M′ is greater than the old M′, the encryption module 400 returns to step 432. Otherwise, post-processing (not shown) can be applied to M′, and then the encryption step 420 terminates.

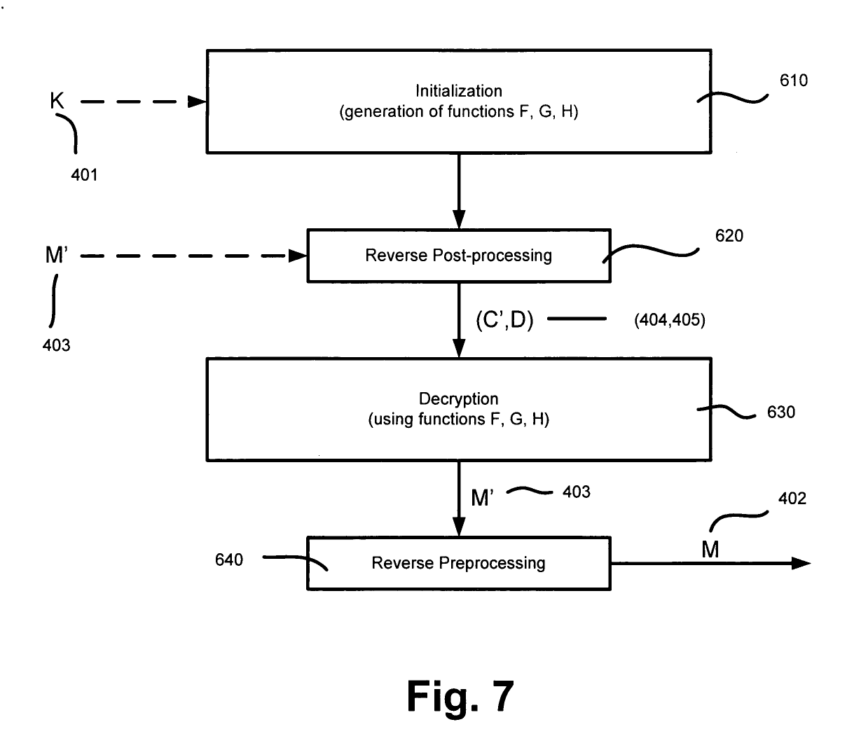

FIG. 7 is a schematic diagram the actions performed by an exemplary decryption module. The key is input to initialization step 610, in which function F, G, and H are generated. The encrypted message M′ 403 is then read. The post-processing step of the encryption module 400 is reversed in step 620 of the decryption module, resulting in one or more pairs (C′ 404, D 405), which are later used in decryption step 630. The decryption step 630 reverses the effects of encryption step 420, and is shown in detail in FIG. 6. M′ 403 is then sent to reverse preprocessing 640, which reverses preprocessing step 410 of encryption module 400, resulting in the decrypted message M 402 being reconstructed.

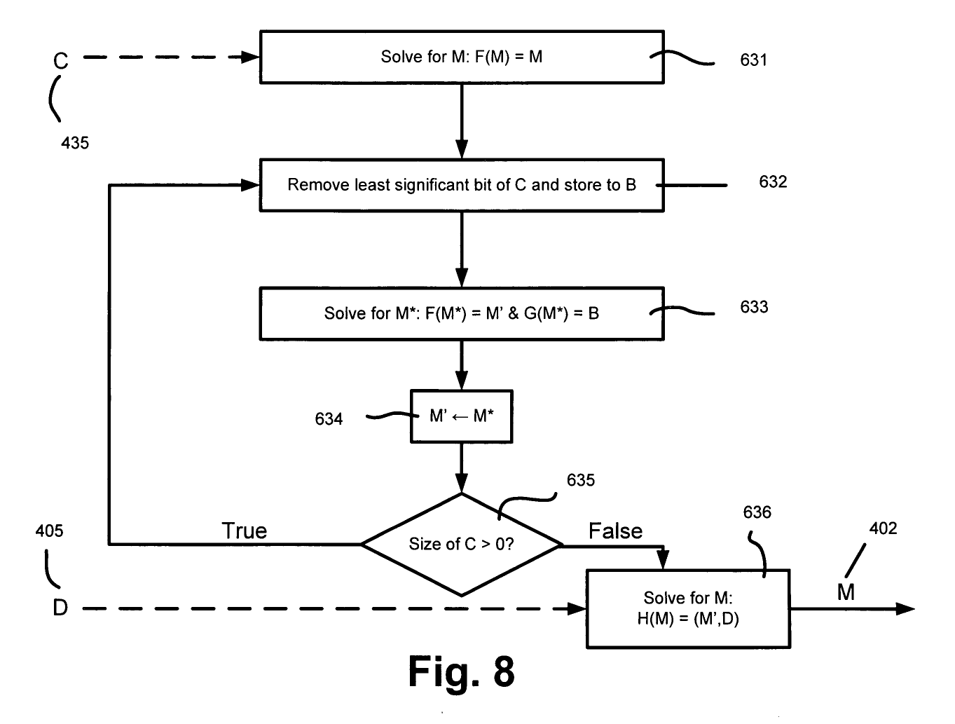

FIG. 8 is a schematic diagram of the decryption step of an exemplary decryption module in more detail. Encrypted message C 435 is input to step 631. In step 631, the unique value of M fulfilling F(M)=M is determined, and this value of M sent to step 632. The least significant bit of C is removed and stored to B in step 632, and the two values M and B are sent to step 633. In step 633, the unique value of M* fulfilling F(M*)=M and G(M*)=B is determined and sent to step 634. In step 634, M is set to equal M*. The values of C and M are then sent to comparison 635. If C contains any more bits, another iteration begins at step 632. Otherwise, step 636 is performed, where M′ is determined from M and D 405 with the reversible equation H(M′)=(M,D). M′ 402 is output to the reverse preprocessor 640.

Whereas the above embodiments have been described in detail, it will be understood that various changes from these embodiments can be made without departing from the scope or sprit of the invention, as set out in the claims.

What is claimed is:

1. A method for encrypting data, the method comprising:
receiving as input a first data set;
reducing the first data set to a reduced data set;
generating an extra data set based on the first data set; and
repeating the reducing and generating if the reduced data set can be further reduced by the reducing.

2. The method of claim 1 wherein the repeating is iterated until a resulting reduced data set can no longer be reduced by the reducing.

3. The method of claim 1 wherein the reducing and the generating are dependent on a key.

4. The method of claim 1 wherein there exists a set U representing the domain of the reducing;
wherein M bits of memory are needed to represent a member of U requiring the least bits of memory for representation without compression;
wherein the reducing comprises transforming the first data set to an output data set such that if the first data set can be represented in N bits of memory without compression, where N is greater than M, then the output data set can also be represented in N bits of memory without compression; and
wherein, if the reducing iterates by repeatedly reducing the result of the previous reduction, then eventually, a resulting output data set could be represented by N−1 bits of memory without compression.

5. The method of claim 1 wherein the reducing and the generating are reversible.

6. The method of claim 1 wherein the extra data set is such that the extra data set and its corresponding reduced data set uniquely determine an enlarged data set, wherein reducing the enlarged data set results in the corresponding reduced data set.

7. The method of claim 1 wherein the reducing reduces the first data set to the reduced data set by calculating
Reduced_Data_Set=(First_Data_Set−First_Data_Set % p)*(qlp);
wherein the extra data set comprises a single bit, and the generating the extra data set comprises calculating
if First_Data_Set % p<p−q, then Extra_Data_Set=0; else Extra_Data_Set=1; and
wherein 2q>p>q.

8. A method for decrypting data, the method comprising:
providing a reduced data set;
receiving ciphertext, which comprises a plurality of data sub-sets;
enlarging the reduced data set to an enlarged data set, wherein the enlarging utilizes one of the plurality of data sub-sets; and
repeating the enlarging if not all of the plurality of data sub-sets have been utilized by the enlarging.

9. The method of claim 8 wherein the repeating is iterated until all of the plurality of data sub-sets have been utilized by the enlarging.

10. The method of claim 8 wherein the enlarging is dependent on a key.

11. The method of claim 8 wherein there exists a set U representing the domain of the enlarging;
wherein M bits of memory are needed to represent a member of U requiring the most bits of memory for representation without compression;
wherein the enlarging comprises transforming the reduced data set to an output data set such that if the output data set can be represented in N bits of memory without compression, where N is less than M, then the reduced data set can also be represented in N bits of memory without compression; and
wherein, if the enlarging iterates by repeatedly enlarging the result of the previous enlargement, then eventually, a resulting output data set would require N+1 bits of memory for representation without compression.

12. A computer-readable medium having computer-readable instructions stored thereon for execution by a processor to perform a method for encrypting data, the method comprising:
receiving as input a first data set;
reducing the first data set to a reduced data set;
generating an extra data set based on the first data set; and
repeating the reducing and generating if the reduced data set can be further reduced by the reducing.

13. The computer-readable medium of claim 12 wherein the repeating is iterated until a resulting reduced data set can no longer be reduced by the reducing.

14. The computer-readable medium of claim 12 wherein the reducing and the generating are dependent on a key.

15. The computer-readable medium of claim 12 wherein there exists a set U representing the domain of the reducing;
wherein M bits of memory are needed to represent a member of U requiring the least bits of memory for representation without compression;
wherein the reducing comprises transforming the first data set to an output data set such that if the first data set can be represented in N bits of memory without compression, where N is greater than M, then the output data set can also be represented in N bits of memory without compression;
and wherein, if the reducing iterates by repeatedly reducing the result of the previous reduction, then eventually, a resulting output data set could be represented by N−1 bits of memory without compression.

16. The computer-readable medium of claim 12 wherein the reducing and the generating are reversible.

17. The computer-readable medium of claim 12 wherein the extra data set is such that the extra data set and its corresponding reduced data set uniquely determine an enlarged data set, wherein reducing the enlarged data set results in the corresponding reduced data set.

18. The computer-readable medium of claim 12 wherein the reducing reduces the first data set to the reduced data set by calculating
Reduced_Data_Set=(First_Data_Set−First_Data_Set % p)*(q/p);
wherein the extra data set comprises a single bit, and the generating the extra data set comprises calculating
if First_Data_Set % p<p−q, then Extra_Data_Set=0; else Extra_Data_Set=1; and
wherein 2q>p>q.

19. A computer-readable medium having computer-readable instructions stored thereon for execution by a processor to perform a method for decrypting data, the method comprising:
providing a reduced data set;
receiving ciphertext, which comprises a plurality of data sub-sets;
enlarging the reduced data set to an enlarged data set, wherein the enlarging utilizes one of the plurality of data sub-sets; and
repeating the enlarging if not all of the plurality of data sub-sets have been utilized by the enlarging.

20. The computer-readable medium of claim 19 wherein the repeating is iterated until all of the plurality of data sub-sets have been utilized by the enlarging.

21. The computer-readable medium of claim 19 wherein the enlarging is dependent on a key.

22. The computer-readable medium of claim 19 wherein there exists a set U representing the domain of the enlarging;
wherein M bits of memory are needed to represent a member of U requiring the most bits of memory for representation without compression;
wherein the enlarging comprises transforming the reduced data set to an output data set such that if the output data set can be represented in N bits of memory without compression, where N is less than M, then the reduced data set can also be represented in N bits of memory without compression; and
wherein, if the enlarging iterates by repeatedly enlarging the result of the previous enlargement, then eventually, a resulting output data set would require N+1 bits of memory for representation without compression.

23. A system of encryption comprising:
a processor;
a memory;
a reducing unit configured to receive a first data set, wherein the reducing unit reduces the first data set to a reduced data set; and
a data-generating unit configured to receive the first data set, wherein the generating unit generates an extra data set;
wherein the reducing unit and the data-generating unit are configured to produce a further reduced data set and an additional extra data set if the reduced data set can be further reduced by the reducing unit.

24. The system of claim 23 wherein the first unit's reducing and the second unit's generating repeat until the reduced data set can no longer be reduced by the reducing.

25. The system of claim 23 wherein the first unit's reducing and the second unit's generating are dependent on a key.

26. The system of claim 23 wherein there exists a set U representing the domain of the reducing;
wherein M bits of memory are needed to represent a member of U requiring the least bits of memory for representation without compression;
wherein the reducing comprises transforming the first data set to an output data set such that if the first data set can be represented in N bits of memory without compression, where N is greater than M, then the output data set can also be represented in N bits of memory without compression; and
wherein, if the reducing iterates by repeatedly reducing the result of the previous reduction, then eventually, a resulting output data set could be represented by N−1 bits of memory without compression.

27. The system of claim 23 wherein the first unit's reducing and the second unit's generating are reversible.

28. The system of claim 23 wherein the extra data set is such that the extra data set and its corresponding reduced data set uniquely determine an enlarged data set, wherein reducing the enlarged data set results in the corresponding reduced data set.

29. The system of claim 23 wherein the reducing reduces the first data set to the reduced data set by calculating
Reduced_Data_Set=(First_Data_Set−First_Data_Set % p)*(q/p);
wherein the extra data set comprises a single bit, and the generating the extra data set comprises calculating
if First_Data_Set % p<p−q, then Extra_Data_Set=0; else Extra_Data_Set=1; and
wherein 2q>p>q.

30. A system of decryption comprising:
a processor;
a memory;
a reversal unit, which enlarges a reduced data set to an enlarged data set;
wherein the enlarging utilizes one of the plurality of data sub-sets;
and wherein the first reversal unit repeats the enlarging if not all of a plurality of data sub-sets have been utilized by the enlarging.

31. The system of claim 30 wherein the reversal unit repeats the enlarging until all of the plurality of data sub-sets have been utilized by the enlarging.

32. The system of claim 30 wherein the reversal unit's enlarging is dependent on a key.

33. The system of claim 30 wherein there exists a set U representing the domain of the enlarging;
wherein M bits of memory are needed to represent a member of U requiring the most bits of memory for representation without compression;
wherein the enlarging comprises transforming the reduced data set to an output data set such that if the output data set can be represented in N bits of memory without compression, where N is less than M, then the reduced data set can also be represented in N bits of memory without compression; and
wherein, if the enlarging iterates by repeatedly enlarging the result of the previous enlargement, then eventually, a resulting output data set would require N+1 bits of memory for representation without compression.
